(19) United States
(12) Patent Application Publication
(10) Pub. No.: US 2025/0296102 A1
(43) Pub. Date: Sep. 25, 2025

(54) PLURAL COMPONENT MATERIAL DISPENSING SYSTEM

(71) Applicant: Graco Minnesota Inc., Minneapolis, MN (US)

(72) Inventors: Daniel P. Ross, Vadnais Heights, MN (US); Andrew M. Spiess, White Bear Lake, MN (US); Austin H. Lindahl, Cambridge, MN (US); Augustine T. Sierra, II, Plymouth, MN (US); Jeremy A. Streit, Brooklyn Park, MN (US); John R. Ingebrand, New Prague, MN (US)

(21) Appl. No.: 18/864,279

(22) PCT Filed: May 9, 2023
(86) PCT No.: PCT/US2023/021448

§ 371 Date: Nov. 8, 2024

Related U.S. Application Data
(60) Provisional application No. 63/340,402, filed on May 10, 2022.

(51) Int. Cl. B05B 7/24; B05B 7/00

(52) U.S. Cl. CPC B05B 7/2497; B05B 7/0025

(57) ABSTRACT

A plural component system includes a first pump configured to pump a first constituent material to an applicator and a second pump configured to pump a second constituent material to the applicator. A controller is operatively connected to the first pump and the second pump to control operation of the first pump and the second pump to pump the first and second constituent materials to the applicator at a desired ratio.

### CROSS-REFERENCE TO RELATED APPLICATION(S)

This application claims the benefit of U.S. Provisional Application No. 63/340,402 filed May 10, 2022 and entitled “SPRAY FOAM SYSTEM,” the disclosure of which is hereby incorporated by reference in its entirety.

### BACKGROUND

The present disclosure relates generally to plural component material systems. More specifically, this disclosure relates to systems for dispensing plural component materials.

Plural component systems are configured to mix individual constituent materials together to form a resultant plural component material that is applied to a substrate. For example, the plural component spray system can be a foam spray system that can spray various foams such as polyurea and other multi-part foam fluids that cure or otherwise set in place. Typical foam spray systems pump first and second constituent materials for combination to form the plural component material (e.g., the spray foam). The constituent materials mix at an applicator, such as a spray gun, to form the plural component material that is applied to a substrate.

It is important to maintain a desired ratio between the multiple constituent materials that are mixed together to form the plural component material to generate a plural component material having desired properties. Typical spray foam systems utilize sets of pumps to drive the constituent materials to the applicator. Such systems include upstream transfer pumps that pump the constituent materials from reservoirs to a proportioner. The proportioner includes dual pumps that pump the material received from the transfer pumps to the applicator. The pumps of the proportioner are configured to maintain the desired ratio between the constituent materials. For example, such proportioner pumps are typically mechanically linked for simultaneous pumping to maintain the on-ratio flow.

Compressed gas can also be supplied. The first constituent material, the second constituent material, and the compressed gas can be mixed in the applicator to react the constituent materials to cure as a foam. The compressed gas can be used to facilitate mixing as well as to propel the mixed material out from a nozzle of the spray gun onto a target surface. The foam can be used for insulation and/or sealing, amongst other potential uses. In many cases, the foam expands shortly after mixing, and can be used to mechanically expand confined areas. In some cases, the foam can be used structurally after setting. The compressed gas can be compressed ambient air or concentrated gas such as nitrogen.

### SUMMARY

According to an aspect of the disclosure, a plural component application system includes a first pump for pumping a first constituent material, the first pump having a first electric motor; a second pump for pumping a second constituent material, the second pump having a second electric motor; an applicator configured to receive the first constituent material and the second constituent material and emit a plural component material formed by mixing of the first constituent material and the second constituent material; and a controller operatively connected to the first electric motor to control pumping by the first pump and to the second electric motor to control pumping by the second pump. The controller is configured to receive first parameter information regarding a first output of the first pump and second parameter information regarding a second output of the second pump; designate a pump status to the first pump and the second pump based on the first parameter information and the second parameter information, wherein the controller designates one of the first pump and the second pump as a lead pump and designates an other one of the first pump and the second pump as a follower pump; and control operation of the follower pump such that a displacement speed of a fluid displacer of the follower pump is based on a displacement speed of a fluid displacer of the lead pump.

According to an additional or alternative aspect of the disclosure, a plural component application system includes a first pump for pumping a first constituent material, the first pump having a first electric motor; a second pump for pumping a second constituent material, the second pump having a second electric motor; an applicator configured to receive the first constituent material and the second constituent material and emit a plural component material formed by mixing of the first constituent material and the second constituent material; and a controller operatively connected to the first electric motor to control pumping by the first pump and to the second electric motor to control pumping by the second pump. The controller is configured to receive first parameter information regarding a first output of the first pump and second parameter information regarding a second output of the second pump; designate a pump status to the first pump and the second pump based on the first parameter information and the second parameter information, wherein the controller designates one of the first pump and the second pump as a lead pump and designates an other one of the first pump and the second pump as a follower pump; control operation of the follower pump such that a displacement speed of a fluid displacer of the follower pump is based on a displacement speed of a fluid displacer of the lead pump; and redesignate the other one of the first pump and the second pump as the lead pump and the one of the first pump and the second pump as the follower pump based on the first parameter information and the second parameter information indicating that an output parameter of the other one of the first pump and the second pump has overtaken an output parameter of the one of the first pump and the second pump.

According to another additional or alternative aspect of the disclosure, a plural component application system includes a first pump for pumping a first constituent material, the first pump having a first electric motor; a second pump for pumping a second constituent material, the second pump having a second electric motor; an applicator configured to receive the first constituent material and the second constituent material and emit a plural component material formed by mixing of the first constituent material and the second constituent material; a user interface configured to receive an output setting from a user, the output setting providing a target output parameter for the plural component material; and a controller operatively connected to the first electric motor to control pumping by the first pump and to the second electric motor to control pumping by the second pump. The controller is configured to receive first pump parameter information regarding the first pump; receive second pump parameter information regarding the second pump; and control operation of the first pump and the second pump based on the output setting, the first pump parameter information, and the second pump parameter information such that the first pump and the second pump output the first constituent material and the second constituent material at a desired ratio.

According to yet another additional or alternative aspect of the disclosure, a plural component application system includes a first pump for pumping a first constituent material, the first pump having a first electric motor; a second pump for pumping a second constituent material, the second pump having a second electric motor, wherein the first pump is not mechanically linked to the first pump for simultaneous pumping; an applicator configured to receive the first constituent material and the second constituent material and emit a plural component material formed by mixing of the first constituent material and the second constituent material; a user interface configured to receive an output setting from a user, the output setting providing a target output parameter for the plural component material; and a controller operatively connected to the first electric motor to control pumping by the first pump and to the second electric motor to control pumping by the second pump. The controller configured to receive first pump parameter information regarding the first pump, the first parameter information including at least one of a current draw of the first electric motor, a rotational speed of a first rotor of the first electric motor, and a displacement speed of a first fluid displacer of the first electric motor; receive second pump parameter information regarding the second pump; and control operation of the first pump and the second pump based on the output setting, the first pump parameter information, and the second pump parameter information such that the first pump and the second pump output the first constituent material and the second constituent material at a desired ratio.

### BRIEF DESCRIPTION OF THE DRAWINGS

FIG. 1 is a schematic view of a plural component dispensing system.

FIG. 2 is a schematic view of a plural component dispensing system.

FIG. 3 is a schematic view of a pump.

### DETAILED DESCRIPTION

The present disclosure concerns systems for applying plural component materials. The system includes first and second pumps that draw respective first and second constituent materials from reservoirs and pump the constituent materials to an applicator for mixing to form a resultant plural component material (e.g., foam, coating, glues, adhesive, etc.). The applicator outputs the resultant plural component material on a target surface. The applicator can generate and output a spray of the plural component material, but not all examples are so limited.

Systems according to the disclosure include a first pump configured to pump a first constituent material to an applicator and a second pump configured to pump a second constituent material to an applicator. A controller is operatively connected to the first pump and the second pump to control operation of the first pump and the second pump. The controller controls operation of the pumps to cause the pumps to pump the first and second constituent materials according to a desired mix ratio at the applicator.

The controller according to aspects of the disclosure can control operation of one of the pumps based on the other pump. The controller can assign one pump as a lead pump and the other pump as a follower pump. The controller controls operation of the follower pump based on the operating parameters of the lead pump. In some examples, the controller controls operation of the follower pump such that the displacement speed of the fluid displacer of the follower pump is based on the displacement speed of the fluid displacer of the lead pump.

The controller according to aspects of the disclosure can determine the pump statuses dynamically during operation of the system. The controller can initially assign one of the pumps as the lead pump and the other pump as the follower pump. The controller can reassign the pump statuses based on the actual operation of the system, such that the pump initially assigned lead pump status is reassigned as the follower pump and the pump initially assigned follower pump status is reassigned as the lead pump.

The controller according to aspects of the disclosure can control operation of the first and second pump based on pump parameter information generated for the first and second pumps, such as current draw of an electric motor, rotational speed/position of a rotor of the electric motor, linear speed/position of a fluid displacer, etc. The controller does not require input from a pressure sensor or flow sensor associated with the flows of the first or second constituent materials.

Systems according to the present disclosure may not include a proportioner pump disposed downstream of the first and second pumps. The system may not include any pump that pumps the first constituent material to the applicator and that is located downstream of the first pump. The system may not include any pump that pumps the second constituent material to the applicator and that is located downstream of the second pump. The first and second pumps are not mechanically linked for pumping, instead the first pump and the second pump are individually controllable.

Components can be considered to radially overlap when those components are disposed at common axial locations along an axis. A radial line extending from the axis will extend through each of the radially overlapping components. Components can be considered to axially overlap when those components are disposed at common radial and circumferential locations such that an axial line parallel to the axis extends through the axially overlapping components. Components can be considered to circumferentially overlap when aligned about the axis, such that a circle centered on the axis passes through the circumferentially overlapping components.

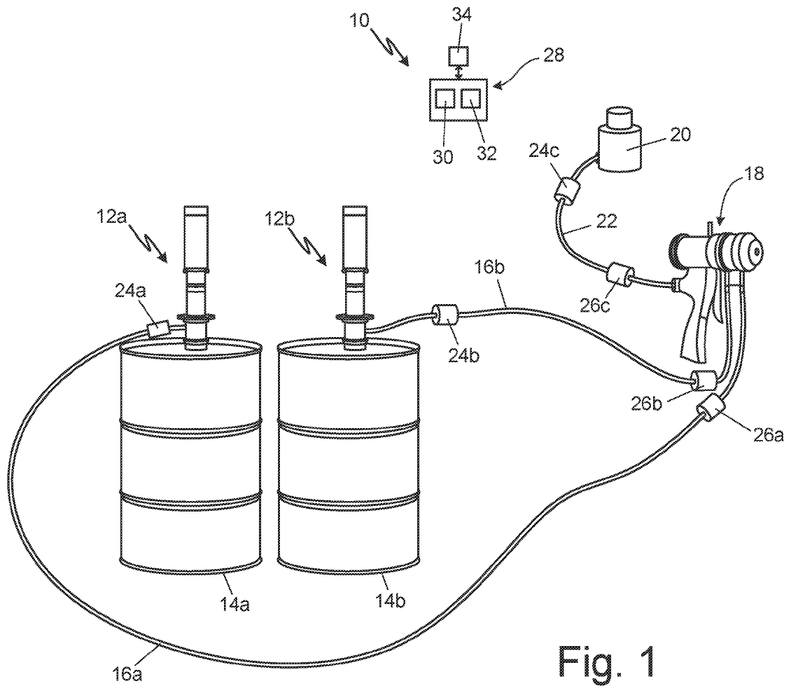

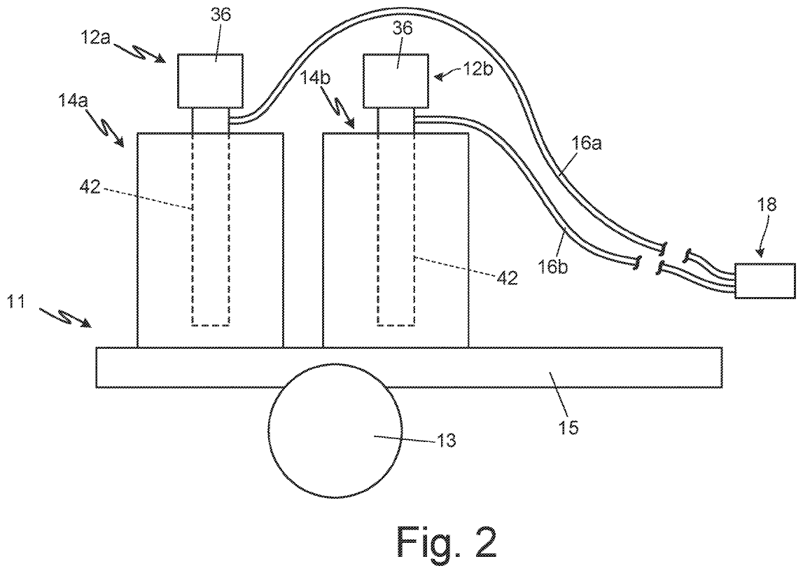

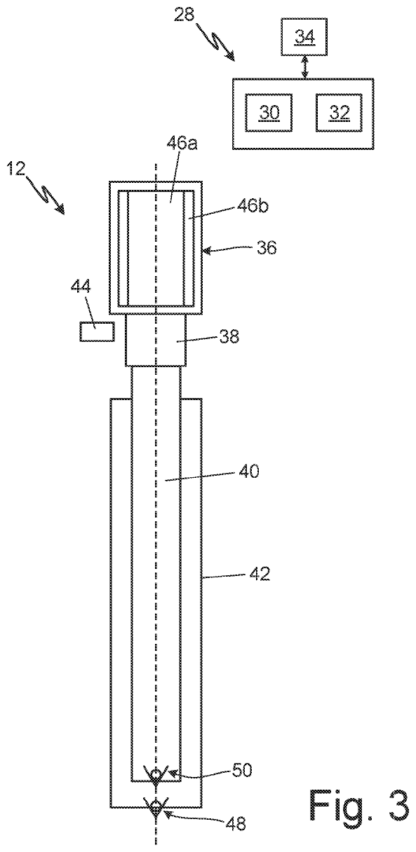

FIG. 1 is a schematic view of plural component system 10. FIG. 2 is a schematic view of plural component system 10 in a mobile configuration. FIG. 3 is a schematic view of pump 12. FIGS. 1-3 will be discussed together. System 10 includes pumps 12a, 12b; reservoirs 14a, 14b; component hoses 16a, 16b; applicator 18; gas supply 20; gas hose 22; heaters 24a-24c; sensor packages 26a-26c; and system controller 28. System controller 28 includes memory 30, control circuitry 32, and user interface 34. Pump 12 includes motor 36, drive 38, fluid displacer 40, housing 42, and pump sensor 44.

System 10 is configured to generate and apply plural component materials on a surface. In some examples, system 10 is configured to generate and apply sprays of the plural component material, through it is understood that not all examples are so limited. For example, system 10 can be configured as a foam spray system that can spray various foams such as polyurea and other multi-part foam fluids that cure or otherwise set in place. The plural component material is formed by mixing flows of individual constituent materials (e.g., a catalyst and a resin) together to form the plural component material. For example, the plural component spray foam can be created by mixing the first constituent material (e.g., isocyanate) and the second constituent material (e.g., polyol resin) to form the resultant foam. The foam can be used for insulation and/or sealing, amongst other potential uses. In many cases, the foam expands shortly after mixing, and can be used to mechanically expand confined areas. In some cases, the foam can be used structurally after setting. While system 10 is described as a foam spray system, it is understood that foam is one broad type of plural component material. Plural component materials can also be glues, adhesives, coatings, epoxies, and other materials. While spray foam will be used as an example, the constituent materials can be any type of component liquids that can be mixed and dispensed. For example, the constituent materials can be mixed to form a plural component material that is applied to flooring, such as an epoxy applied to flooring. The mixtures are combined in the applicator 18 and emitted as a single solution. The applicator 18 can be configured as a sprayer but not all examples are so limited. Applicator 18 can be configured to output the plural component material without generating a spray.

It is understood that anything shown or described herein as a single hose can be a series of connected hoses. Anything described herein or shown as a single component can be multiple components.

Reservoirs 14a, 14b are configured to store supplies of the constituent materials. Reservoir 14a is fluidly separate from reservoir 14b and the constituent materials do not mix except at applicator 18. Reservoir 14a stores a supply of the first constituent material, which can be referred to as an A component material. Reservoir 14b stores a supply of the second constituent material, which can be referred to as a B component material. The component reservoirs 14a, 14b can be drums, buckets, tubs, bags, or other types of reservoirs. The component reservoirs 14a, 14b contain respective constituent materials that react when mixed to cure, such as to form a foam. Pumps 12a, 12b are configured to pump the constituent materials from reservoirs 14a, 14b, respectively, to applicator 18 for mixing and application. Each of pumps 12a, 12b can be formed as a pump 12. The pumps 12a, 12b can be collectively referred to herein as “pump 12” or “pumps 12”. Pump 12 includes electric motor 36. The motor 36 includes motor components 46a, 46b. Motor 36 can be configured as a rotating rotor-stator type electric motor. One of motor components 46a, 46b is formed as a rotor configured to rotate during operation to provide an input for displacing fluid displacer 40 and the other one of motor components 46a, 46b is formed as a stator that is configured to drive rotation of the rotor. The stator is configured to receive electrical power and generate an electromagnetic field to drive rotation of the rotor. In some examples, the rotor can be disposed radially within the stator such that motor 36 is an inner rotating motor. In such an example, the motor component 46a can form the rotor and the motor component 46b can form the stator. In some examples, the stator can be disposed radially within the rotor such that motor 36 is an outer rotating motor. In such an example, the motor component 46a can form the stator and the motor component 46b can form the rotor. The motor 36 drives displacement of fluid displacer 40.

Fluid displacer 40 is configured to move to pump the constituent material. For example, fluid displacer 40 can be configured to reciprocate along a pump axis PA to pump the constituent material, though it is understood that not all examples are so limited. In the example shown, the fluid displacer 40 can be configured as a piston or a diaphragm, among other options.

Housing 42 forms a lower portion of pump 12. Housing 42 can extend into a reservoir 14a, 14b associated with the pump 12. For example, housing 42 can extend to be at least partially immersed within the constituent material held within the reservoir 14a, 14b. Housing 42 can be formed as a cylinder within which fluid displacer 40 reciprocates, among other options. Fluid displacer 40 is at least partially disposed within housing 42. In some examples, such as when fluid displacer 40 is formed as a piston, the fluid displacer 40 can move through a pump cycle including a suction stroke and a pressure stroke. Either of the suction stroke and the pressure stroke can be referred to as a pump stroke. Fluid displacer 40 moves upwards in the suction stroke to pull component material through inlet check valve 48 while outlet check valve 50 is closed. Outlet check valve 50 can be carried by the fluid displacer 40, such as within a piston forming fluid displacer 40. Fluid displacer 40 moves downward through the pressure stroke during which inlet check valve 48 is closed and outlet check valve 50 is open, displacing constituent material from an upstream chamber within housing 42 to a downstream chamber within housing 42. Pump 12 can be formed as a double displacement pump in which component material is output from the pump 12 during both the suction stroke and the pressure stroke.

Drive 38 is disposed between and connects motor 36 and fluid displacer 40. Drive 38 is configured to receive a rotational output from motor 36 and convert that rotational motion into linear motion. The drive 38 is configured to provide a linear input to fluid displacer 40 to drive reciprocation of fluid displacer 40 in the example shown. For example, drive 38 can be configured as a screw and drive nut, a crank, a scotch yoke, among other options. In the example shown, motor 36, drive 38, and fluid displacer 40 are disposed coaxially on pump axis PA, though it is understood that not all examples are so limited.

Pump sensor 44 is configured to generate parameter information regarding an operating parameter of pump 12. For example, pump sensor 44 can be configured to generate information regarding a speed of motor 36 (e.g., rotational speed of the rotor of motor 36), a speed of fluid displacer 40 (e.g., directly by measuring displacement speed or indirectly by measuring the speed of motor 36), a position of motor 36 (e.g., rotational position of the rotor of motor 36), power consumption of the motor 36 (e.g., current draw), etc. The pump sensor 44 can be configured as one or more sensors for measuring one or more of the rotational position and/or rotational speed of the electric motor 36, the linear position and/or linear speed of the fluid displacer 40, the current draw of the motor 36, etc. For example, such sensors can determine whether the fluid displacer is near or at its changeover point at which point the fluid displacer 40 switches direction of travel between pump strokes as the fluid displacer reciprocates. Pump sensor 44 is operatively connected to system controller 28, electrically and/or communicatively, to provide the parameter information to the controller 28. The parameter information generated by pump sensor 44 can be referred to as pump parameter information. The parameter information generated by pump sensor 44 can be referred to as motor parameter information in examples in which the parameter information is sensed from the motor 36, such as for rotational speed, rotational position, and current draw.

Pumps 12a, 12b are independently controlled and operated pumps. Pumps 12a, 12b are not mechanically linked for simultaneous pumping. Instead, the motor 36 of pump 12a drives the fluid displacer 40 of pump 12a while the motor 36 of pump 12b drives the fluid displacer 40 of pump 12b. The pumps 12a, 12b are not powered by a single motor. The controller 28 provides operating commands to each motor 36 of each pump 12a, 12b to cause operation of each pump 12a, 12b independent of the other pump 12a, 12b.

Applicator 18 is configured to emit the plural component material for application on a substrate. In some examples, applicator 18 is configured as a sprayer for emitting a spray of the plural component material. For example, applicator 18 can be configured as a spray gun. In the example shown, applicator 18 is configured as a handheld spray gun, including a handle for grasping by a user and a trigger for actuating by the user to control spraying by the applicator 18. It is understood, however, that in other examples the applicator 18 can be configured as an automatic sprayer that is activated remotely, such as via flows of compressed gas, among other options. In such an example, the applicator 18 can be mounted to a robotic arm for aiming and manipulation. In still other examples the applicator 18 is configured to emit the plural component material in a configuration other than as a spray.

As shown in FIG. 3, system 10 can be configured as a mobile system. Such a mobile system can be transported between job sites. In the example shown, mobile platform 11 that includes support base 15 supported by wheels 13. In some examples, mobile platform 11 can include a hitch or other connector configured to connect mobile platform to a vehicle, such as a truck. In some examples, mobile platform 11 can be self-propelled. For example, mobile platform 11 can be formed by the bed of a vehicle or by a box supported by the frame of the vehicle.

Reservoirs 14a, 14b are disposed on mobile platform 11. Pumps 12a, 12b are supported by reservoirs 14a, 14b respectively such that housings 42 of pumps 12a, 12b extend into and are at least partially immersed within the constituent materials held within the reservoirs 14a, 14b. Motors 36 are disposed outside of and vertically above the reservoirs 14a, 14b.

The constituent materials within reservoirs 14a, 14b are kept separate and are only mixed within the applicator 18. Hose 16a extends from the pump 12a to an inlet of the applicator 18a to carry the first constituent material from the first reservoir 14a to the first inlet of the applicator 18a. Hose 16b extends from the pump 12b to an inlet of the applicator 18 to carry the second constituent material from the second reservoir 14b to the second inlet of the applicator 18. The first and second constituent materials can be continuously mixed in a chamber of the applicator 18 during triggering of the applicator 18 just before being emitted from a nozzle of the applicator 18 as the plural component material. Applicator 18 can be configured to block flows of the constituent materials to the chamber when applicator 18 is detriggered, preventing formation and emission of the plural component material.

Heater 24a is operatively associated with the first constituent material and is configured to provide heat to the first constituent material. In some examples, heater 24a can be configured as multiple discrete heaters that heat the first constituent material. While the heater 24a is located along the first hose 16a to heat the first component as it passes through the first hose 16a, the first heater 24a can additionally and/or alternatively be located in or on the first reservoir 14a or in the applicator 18. In some examples, heater 24a extends along most or up to all of the length of hose 16a.

Heater 24b is operatively associated with the second constituent material and is configured to provide heat to the second constituent material. In some examples, heater 24b can be configured as multiple discrete heaters that heat the second constituent material. While the heater 24b is located along the second hose 16b to heat the second component as it passes through the second hose 16b, the second heater 24b can additionally and/or alternatively be located in or on the second reservoir 14b or in the applicator 18. In some examples, heater 24b extends along most or up to all of the length of hose 16b.

Sensor package 26a is located along the flow path between the output of pump 12a and the mix chamber of the applicator 18. As shown in this embodiment, the first sensor package 26a is operatively associated with the hose 16a to sense one or more parameters of the first constituent material along the hose 16a. In some examples, sensor package 26a can be mounted to hose 16a. Sensor package 26a can include one or more sensors configured to generate parameter information regarding the first constituent material flowing within hose 16a. For example, sensor package 26a can include one or more of a pressure sensor, a flow sensor, a temperature sensor, among other options. The parameter information can be pressure (e.g., via a pressure transducer), flow (e.g., via a flow meter), and/or a temperature (e.g., via a thermistor), among other parameters of the first constituent material. While sensor package 26a is shown as located along hose 16a, it is understood that sensor package 26a can be located in other locations including in the pump 12a and/or in the applicator 18, amongst other locations. The sensor package 26a is operatively connected, electrically and/or communicatively, to system controller 28 to provide the parameter information to system controller 28. The parameter information generated by sensor package 26a can also be referred to as material parameter information or first material parameter information.

Sensor package 26b is located along the flow path between the output of pump 12b and the mix chamber of the applicator 18. As shown in this embodiment, the second sensor package 26b is operatively associated with the hose 16b to sense one or more parameters of the second constituent material along the hose 16b. In some examples, sensor package 26b can be mounted to hose 16b. Sensor package 26b can include one or more sensors configured to generate parameter information regarding the second constituent material flowing within hose 16b. For example, sensor package 26b can include one or more of a pressure sensor, a flow sensor, a temperature sensor, among other options. The parameter information can be pressure (e.g., via a pressure transducer), flow (e.g., via a flow meter), and/or a temperature (e.g., via a thermistor), among other parameters of the second constituent material. While sensor package 26b is shown as located along hose 16b, it is understood that sensor package 26b can be located in other locations including in the pump 12b and/or in the applicator 18, amongst other locations. The sensor package 26b is operatively connected, electrically and/or communicatively, to system controller 28 to provide the parameter information to system controller 28. The parameter information generated by sensor package 26b can also be referred to as material parameter information or second material parameter information.

While system 10 is described as including sensor packages 26a, 26b for sensing parameters of the first and second constituent materials, it is understood that not all examples are so limited. Some examples of system 10 do not include sensor packages 26a, 26b and/or system controller 28 is configured such that system controller 28 does not rely on the material parameter information generated by sensor packages 26a, 26b to control operation of pumps 12a, 12b, as discussed in more detail below.

Gas supply 20 is fluidly connected to applicator 18 to provide compressed gas to applicator 18. The gas supply 20 can be a compressor for compressing and supplying ambient air. The gas supply 20 can be a tank or other type of reservoir that contains and supplies a gas under pressure, such as atmospheric gas or a concentrated gas, such as nitrogen, amongst other options. Gas hose 22 extends from the gas supply 20 to an inlet of the applicator 18 to supply compressed gas to the applicator 18. The compressed gas can be mixed with the first and the second constituent materials within the applicator 18 to mix and propel the mixture from the nozzle of the applicator 18.

Heater 24c can be located along the gas supply circuit, such as part of the gas supply 20 or along the gas hose 22, or in the applicator 18, for heating the gas before the gas is mixed with the first and the second constituent materials. However, various embodiments may not include heating of the compressed gas.

Sensor package 26c is positioned to generate parameter information regarding the compressed gas. As shown, the sensor package 26c is mounted along the gas hose 22. However, the sensor package 26c can additionally or alternatively be located in the gas supply 20 and/or the applicator 18 to measure the parameter of the gas. For example, sensor package 26c can include one or more of a pressure sensor, a flow sensor, a temperature sensor, among other options. Such parameters of the compressed gas can be pressure (e.g., via a pressure transducer), flow (e.g., via a flow meter), and/or a temperature (e.g., via a thermistor), amongst other parameters of the gas. In some examples, sensor package 26c includes a valve or other type of regulator that can modulate the supply of the compressed gas to the applicator 18. Additionally or alternatively, the gas supply 20 can modulate the supply of compressed gas to the applicator 18. The parameter information generated by sensor package 26a can also be referred to as gas parameter information.

Each of pump 12a, pump 12b, sensor package 26a, sensor package 26b, and sensor package 26c can communicate with the system controller 28. In some cases, the communication can be one way, such as from the sensor package 26a-26c or pump 12a, 12b to the controller 28, or can be bidirectional, such as between the sensor package and the controller 28 in one aspect and between each of the first pump 12a and the second pump 12b and the controller 28 in another aspect. In various embodiments, communication can take place between the gas supply 20 and the controller 28, for example the controller 28 commanding the gas supply 20 to increase or decrease flow and/or pressure output. Communication can take place in various embodiments between controller 28 and the heaters 24a-24c, such as to increase or decrease thermal output to control temperatures of the constituent materials and compressed gas. Communication between the various components can be wired and/or wireless communications.

Controller 28 can include one or more processors for carrying out the functions described herein. Controller 28 may be separate from the first and the second pumps 12a, 12b as shown, or may be integrated into one or both of the motors 36 of the pumps 12a, 12b. As shown, the first pump 12a is separate from the second pump 12b. In some cases, the first pump 12a does not communicate directly with the second pump 12b, such that all communication is from the respective pump 12a, 12b to the controller 28 and back to the respective pump 12a, 12b, but not between pumps 12a, 12b, however not all embodiments are so limited.

Controller 28 is operatively connected to other components of system 10 to control operation of the other components of system 10. Controller 28 is configured to store software, implement functionality, and/or process instructions. Controller 28 is configured to perform any of the functions discussed herein, including receiving an output from any sensor referenced herein, detecting any condition or event referenced herein, and controlling operation of any components referenced herein. Controller 28 can be of any suitable configuration for controlling operation of components of system 10 (e.g., motors 36 of pumps 12a, 12b, gas supply 20, etc.), receiving signals from components of system 10 (e.g., pump sensors 44 of pumps 12, sensor packages 26a-26c, etc.), gathering data, processing data, etc. Controller 28 can include hardware, firmware, and/or stored software, and controller 28 can be entirely or partially mounted on one or more circuit boards. Controller 28 can be of any type suitable for operating in accordance with the techniques described herein.

Control circuitry 32, in one example, is configured to implement functionality and/or process instructions. For example, control circuitry 32 can be capable of processing instructions stored in memory 30. Examples of control circuitry 32 can include one or more of a processor, a microprocessor, a controller, a digital signal processor (DSP), an application specific integrated circuit (ASIC), a field-programmable gate array (FPGA), or other equivalent discrete or integrated logic circuitry. Control circuitry 32 can be entirely or partially mounted on one or more circuit boards.

Memory 30 can be configured to store information before, during, and/or after operation. Memory 30, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 30 is a temporary memory, meaning that a primary purpose of memory 30 is not long-term storage. Memory 30, in some examples, is described as volatile memory, meaning that memory 30 does not maintain stored contents when power to controller 28 is turned off. Examples of volatile memories can include random access memories (RAM), dynamic random access memories (DRAM), static random access memories (SRAM), and other forms of volatile memories. In some examples, memory 30 is used to store program instructions for execution by control circuitry 32. Memory 30, in one example, is used by software or applications to temporarily store information during program execution. Memory 30 can be configured to store larger amounts of information than volatile memory. Memory 30 can further be configured for long-term storage of information. In some examples, memory 30 includes non-volatile storage elements. Examples of such non-volatile storage elements can include magnetic hard discs, optical discs, flash memories, or forms of electrically programmable memories (EPROM) or electrically erasable and programmable (EEPROM) memories.

User interface 34 is configured to receive inputs from a user to provide to controller 28 and/or provide outputs to the user. User interface 34 can be any graphical and/or mechanical interface that enables user interaction with controller 28. For example, user interface 34 can implement a graphical user interface displayed at a display device of user interface 34 for presenting information to and/or receiving input from a user. User interface 34 can include graphical navigation and control elements, such as graphical buttons or other graphical control elements presented at the display device. User interface 34, in some examples, includes physical navigation and control elements, such as physically actuated buttons or other physical navigation and control elements. In general, user interface 34 can include any input and/or output devices and control elements that can enable user interaction with controller 28.

User interface 34 is configured to receive an output setting from a user. The output setting sets a target output parameter for the material flow from pumps 12a, 12b. The target output parameter can be a target pressure or a target flow rate, among other options. In some examples, the output setting can set a target temperature for the constituent materials.

Controller 28 is configured to control operation of the pumps 12a, 12b to provide the first and second constituent materials to applicator 18 at a desired ratio between the constituent materials. For example, the controller 28 can control the motor speed of the electric motor 36 of each pump 12a, 12b based on the desired ratio to maintain a target flow ratio between the first constituent material and the second constituent material. The motor speed is directly correlated to the speed of the fluid displacer 40 of the pump 12. The controller 28 is further configured to control operation of the pumps 12a, 12b based on the output setting input at the user interface 34. For example, the controller 28 can control operation of pumps 12a, 12b to pump based on the target pressure, based on the target flow rate, etc.

In some examples, the pump 12a and the pump 12b are commonly sized to have the same or similar displacement per pump stroke. In such an example, the motor speed of each pump 12a, 12b can be maintained equal to provide a 1:1 constituent material output from each pump 12a, 12b. In various embodiments, the controller 28 can synch the motor speed of each of the first and the second pumps 12a, 12b. The speeds can be synced such that the speeds of the fluid displacers 40 of the pumps 12a, 12b are equal and/or changeovers occur simultaneously. Equal speeds can result in the first pump 12a and the second pump 12b outputting the same volume rate, which can be useful for 1:1 ratio mixing of the first and the second constituent materials. In some embodiments, the motor 36 that drives the first pump 12a can operate at a different speed than the motor 36 that drives the second pump 12b so that different flow rates of the first and the second constituent materials are output by the first and the second pumps 12a, 12b respectively, to maintain mix ratios that are not 1:1.

In some examples, the pump 12a and the pump 12b can be differently sized to have different outputs per pump stroke. In such an example, the motor speeds of the pumps 12a, 12b can be controlled relative to each other based on the relative displacement between the pumps 12a, 12b to provide a desired output ratio. In such an example, controller 28 can maintain the motor 36 of pump 12a at a different speed from the motor 36 of pump 12b to provide a 1:1 mix ratio even when pumps 12a, 12b are not commonly sized. For example, if pump 12a is sized to output twice the amount of material as pump 12b per pump stroke, then controller 28 can sync the speeds of the motors 36 of pump 12a and pump 12b to have equal speed to provide an output ratio of 2:1. If a 1:1 output ratio is desired, then controller 28 can sync the speeds of the pumps 12a, 12b by controlling the motor 36 of pump 12a to move at half the speed of the motor 36 of pump 12b to provide the desired 1:1 output ratio.

Any of the sensors referenced herein can monitor any of the parameters mentioned herein and transmit that information to the controller 28. The controller 28 can instruct either of the first pump 12a or the second pump 12b to adjust to any parameter (e.g., motor torque, speed) to counteract low or high fluid pressure, low or high of flow, or off-ratio mixing. For example, if the second sensor package 26b senses a decrease in pressure and/or flow rate of the second constituent material, the second sensor package 26b can communicate that information to the controller 28 and the controller 28 can then control the first pump 12a to adjust (e.g., lower) its motor speed to correspondingly lower the fluid output pressure and/or flow rate output from the first pump 12a so that the pressures and/or flow rates of the first and the second constituent materials in the applicator 18 are equal or on a specified ratio.

Additionally or alternatively, the controller 28 can instruct one or both of the first heater 24a or the second heater 24b to increase or decrease its thermal input into the first or the second constituent material, respectively, which can increase or decrease pressures and flowrates of the first and the second constituent materials in their respective hoses 16a, 16b so that the pressures and/or flow rates of the first and the second constituent materials in the applicator 18 are equal or on a specified ratio.

In various embodiments, the controller 28 can receive data indicative of the temperature of one or both of the first constituent material and the second constituent material from the first sensor package 26a or the second sensor package 26b. If the temperature of the first constituent material falls below a threshold temperature as sensed by the first sensor package 26a, then the controller 28 can command the first pump 12a to increase its motor speed and/or torque to generate one or both of higher flow or higher pressure to compensate for the decrease in temperature. If the temperature of the second component falls below a threshold temperature as sensed by the second sensor package 26b, then the controller 28 can command the second pump 12b to increase its motor speed and/or torque to generate one or both of higher flow or higher pressure to compensate for the decrease in temperature.

Controller 28 can be configured to assign a status to each of pumps 12a, 12b and control operation of pumps 12a, 12b based on the designated statuses. One of pumps 12a, 12b is designated as the lead pump, which can also be referred to as the leader, and the other one of pumps 12a, 12b is designated as the follower pump, which can also be referred to as the follower. The lead pump sets the baseline parameter level for the pumps 12a, 12b while the follower pump is controlled based on the baseline parameter level of the lead pump. In some examples, the lead pump sets the baseline speed of the pumps 12a, 12b while the follower pump is controlled based on the speed of the lead pump. In such an example, the controller 28 controls operation of the follower pump based on the operation of the lead pump. For example, the controller 28 can control the lead pump based on the output setting provided from the user interface 34 and the controller 28 can control the follower pump based on the lead pump.

During operation, the user sets a target output parameter for the pumps 12a, 12b. The target output parameter can be set by inputting the output setting at the user interface. For example, the target output parameter can be a pressure, flow rate, etc. The controller 28 causes the pumps 12a, 12b to operate to output the constituent materials. The constituent materials differ from each other such that the materials can have different viscosities, resulting in one constituent material flowing easier than the other constituent material. If each pump 12a, 12b was individually controlled to a target pressure, the pump 12a, 12b driving the less viscous material would have to achieve a higher flow rate to output the material at the desired pressure, leading to off-ratio provision of the constituent materials to the applicator 18.

Controller 28 sets the target output parameter and commands pumps 12a, 12b to output constituent material based on the target output parameter. The controller 28 receives parameter information regarding the output from pumps 12a, 12b (e.g., from sensor package 26a or pump sensor 44a for the output of pump 12a and from sensor package 26b and/or pump sensor 44b for the output of pump 12b). For purposes of this example, the target output parameter is assumed to be pressure, though it is understood that the target output parameter can be flow rate, among other options.

Pumps 12a, 12b pump the constituent materials through hoses 16a, 16b. The pressure of the constituent materials is sensed and provided to controller 28. For example, the pressure can be sensed by pressure sensors of the sensor packages 26a, 26b. In some examples, the pressure is determined based on pump parameter data. For example, the pressure output of pumps 12a, 12b can be determined based on the current draw of the motors 36 of the pumps 12a, 12b. The controller 28 designates the pump 12a, 12b that has the higher pressure output (e.g., as directly sensed by a sensor package 26a, 26b or as determined based on electric current draw) as the lead pump. The controller 28 determines the pump 12a, 12b that has the higher pressure output and designates that pump 12a, 12b as the lead pump. The controller 28 determines a speed of the lead pump 12a, 12b (e.g., the speed of the motor 36 (e.g., in rotations of the rotor of the motor 36 per time unit) and/or the speed of displacement of the fluid displacer 40 (e.g., linear distance per time unit)), such as based on pump parameter information from pump sensor 44.

The controller 28 controls operation of the follower pump based on the operation of the lead pump. The controller 28 commands the motor 36 of the follower pump such that the speed of the follower pump synchs with the speed of the lead pump. The follower pump operating at a synched speed (e.g., the same speed for pumps 12a, 12b having the same displacement in a 1:1 ratio application) with the lead pump causes the pumps 12a, 12b to output the constituent materials according to the desired mixing ratio. The controller 28 can vary operation of the follower pump based on the operation of the lead pump during operation of the system 10.

The controller 28 determines which of the pumps 12a, 12b is the lead pump during operation of the system 10. The controller 28 sets the lead pump based on parameter information regarding the output from the pumps 12a, 12b. Assigning the lead pump based on the actual operation of system 10 provides a more efficient system that is responsive to the actual operating conditions of the system 10. For example, pre-assigning which pump 12a, 12b is the lead pump can lead to off-ratio mixing when the assumed differences in viscosity are not present. For example, the constituent material that is typically more viscous could be in a reservoir 14a, 14b that is located in sunlight while the constituent material that is typically less viscous could be in a reservoir 14a, 14b that is located in shade, leading to relative heating of that more viscous material which in turn decreases viscosity. The controller 28 determining and assigning which pump 12a, 12b is the lead pump based on actual operation of system 10 provides on-ratio mixing at the desired operating parameter, providing a resultant plural component material that has desired properties.

For example, the target output parameter can be a pressure of 1,000 pounds per square inch (psi) (about 6.89 Megapascal (MPa)). The controller 28 can be configured to assign lead pump status and follower pump status based on a designation threshold. The designation threshold is set based on the target operating parameter. For example, the controller 28 can determine that pump 12a is the lead pump and pump 12b is the follower pump based on the parameter information indicating that the output of pump 12a has satisfied the designation threshold.

In some examples, the designation threshold is associated with the individual outputs of pump 12a and pump 12b. For example, the controller 28 can be configured to identify the lead pump based on the actual output from the pumps 12a, 12b. In such an example, controller 28 can monitor the parameter information regarding the outputs of pumps 12a, 12b (e.g., from pump sensors 44 and/or sensor packages 26a, 26b) and designate the lead pump based on whichever of pumps 12a, 12b is first to reach the designation threshold. For example, controller 28 can designate pump 12a as the lead pump if pump 12a achieves the 1,000 psi output before pump 12b achieves the 1,000 psi output. The controller 28 can then control system 10 based on maintaining the output of the lead pump at the desired output parameter. For example, the controller 28 can increase the speed of the lead pump, and correspondingly of the follower pump, based on a sensed pressure drop in the output of the lead pump or can decrease the speed of the lead pump, and correspondingly of the follower pump, based on a sensed pressure rise in the output of the lead pump.

In some examples, the designation threshold is associated with a combined output of the pumps 12a, 12b. For example, the controller 28 can be configured to identify the lead pump based on an average parameter value for the pumps 12a, 12b. In such an example, controller 28 can monitor the parameter information regarding the outputs of pumps 12a, 12b (e.g., from pump sensors 44 and/or sensor packages 26a, 26b) and designate the lead pump based on the averaged output reaching the designation threshold. In such an example, the controller 28 can determine that the designation threshold is satisfied based on the averaged output of the pumps 12a, 12b. For example, the controller 28 can designate pump 12a as the lead pump based on pump 12a outputting at a higher pressure than pump 12b when the average outputs of pumps 12a, 12b reaches the 1,000 psi target output pressure. For example, pump 12a outputting at 1,200 psi (about 8.27 MPa) and pump 12b outputting at 800 psi (about 5.52 MPa).

In some examples, controller 28 is configured to assign the lead pump during initiation of an operation. For example, the controller 28 can assign the lead pump at the onset of operation of system 10. The controller 28 can be configured to determine and assign the lead pump status on each initiation of system 10. The controller 28 can be configured to make the lead pump determination at the initiation of operations and can reassign the lead pump each time a new operation is initiated (e.g., after replacing a reservoir 14a, 14b with a new reservoir 14a, 14b of material, at the start of a new job, on powering of system 10, after a certain threshold time of inactivity (e.g., thirty minutes, one hour, etc.), among other options).

In some examples, controller 28 is configured to dynamically assign the lead pump and follower pump statuses during operation of system 10. In some examples, the controller 28 is configured to dynamically determine and assign the lead pump and follower pump statuses based on a comparison of the parameter information for each pump 12a, 12b. For example, the controller 28 can initially determine that pump 12a is the lead pump and pump 12b is the follower pump. Controller 28 continues to monitor the outputs from pumps 12a, 12b. If there is an inversion of which pump 12a, 12b is the higher pressure pump, such that the pressure output of pump 12b exceeds the pressure output of pump 12a, then controller 28 can reassign lead pump status to the pump 12b that has the higher pressure output and assign follower pump status to pump 12a. The controller 28 can reassign pump statuses based on a pump parameter of the follower pump overtaking a pump parameter of the lead pump (e.g., the pressure output of the follower pump exceeds the pressure output of the lead pump, the follower pump has greater current draw than the lead pump, etc.). In such an example, controller 28 will then control pump 12b (reassigned as the lead pump) based on the target output parameter and control pump 12a (reassigned as the follower pump) based on the operating parameters of pump 12b. For example, the controller 28 can implement a status change such that the pump 12a, 12b that was previously the follower pump becomes the lead pump and the pump 12a, 12b that was previously the lead pump becomes the follower pump.

Dynamically determining and assigning statuses of the pumps 12a, 12b during operation provides a responsive system 10 that dynamically responds to real world conditions experienced during application of the plural component material. The viscosities of the constituent materials can change due to environmental conditions, affecting flow rate and pressure. Reassigning lead pump and follower pump statuses maintains on-ratio provision of the constituent materials to the applicator 18, providing for efficient operations and high quality plural component material.

In some dynamic status examples, the controller 28 is configured to implement the status change for the pumps 12a, 12b between lead and follower pump based on a status threshold. For example, assuming pump 12a is the lead pump and pump 12b is the follower pump, pump 12a remains the lead pump until the status threshold is reached. The status threshold can be based on one or more of pump cycles, time, average current draw, average pressure output, average flow rate, among other options. In a pump cycle example, the status threshold can be based on the measured output parameter from the follower pump (e.g., pressure or flow rate) exceeding the measured output parameter from the lead pump over a certain number of pump cycles. In a temporal example, the status threshold can be based on the measured output parameter from the follower pump exceeding the measured output parameter from the lead pump over a certain time period (e.g., thirty seconds, one minute, two minutes, etc.). In an average parameter example, the measured parameter of the pump 12a, 12b that is utilized to determine the lead pump (e.g., pressure, current draw, flow rate, etc.) is averaged over a period (e.g., time, pump cycles, etc.) and the averaged parameters for the pumps 12a, 12b are compared to determine which pump 12a, 12b should be designated the lead pump and which pump 12a, 12b should be designated the follower pump. The pump 12a, 12b having the higher average is designated as the lead pump. The averaged parameter can be a rolling average (e.g., over the previous one minute, five minutes, fifteen pump cycles, fifty pump cycles, etc.).

Implementing a status threshold provides efficient operation of system 10 that facilitates on-ratio mixing. The pressure output by pumps 12a, 12b can fluctuate as the fluid displacer 40 reciprocates within housing 42, such as when fluid displacer 40 reverses direction at changeover between suction and pressure strokes. The current draw by pumps 12a, 12b can fluctuate as fluid displacer 40 reciprocates within housing 42. The status threshold prevents oscillation between pump statuses due to transient parameter measurements, providing for efficient pumping and consistent flow of material to applicator 18.

In some examples, the controller 28 can control the respective motors 36 of the pumps 12a, 12b to turn on and/or turn off at the same time, such that both motors 36 turn on at the same time and/or turn off of the same time. Such turning on and turning off of the motors 36 can be responsive to any parameter referenced herein regarding the pumps 12a, 12b, sensor package 26a, and/or sensor package 26b. For example, an increase in pressure from any one sensor in either sensor package 26a, 26b or a rise in current draw in either motor 36 can indicate detriggering of the applicator 18 and thus the need to stop pumping, such that the controller 28 instructs both pumps 12a, 12b to stop. A drop in pressure from any one sensor in either sensor package 26a, 26b or a drop in current draw can indicate triggering of the applicator 18 and thus the need to start pumping, such that controller 28 instructs both pumps 12a, 12b to start.

Changes in current draw of motors 36 of either pump 12a, 12b can indicate starting or stopping of emission of the plural component material. For example, an increase in current draw, such as a spike in current, can indicate detriggering of applicator 18 and thus the need to stop pumping, such that controller 28 instructs both pumps 12a, 12b to stop pumping. In some examples, motors 36 can be supplied with current when applicator 18 is detriggered, such as a current level below that required for pumping, and such that motors 36 apply torque and urge on fluid displacer 40 when applicator is detriggered. Input from pump sensor 44 can indicate movement of motor 36 (e.g., rotation of the rotor or linear displacement of the fluid displacer 40) while urging, indicating triggering of applicator 18 and thus the need to start pumping, such that controller 28 instructs both pumps 12a, 12b to start pumping.

In some examples, the controller 28 can control the respective motors 36 of the pumps 12a, 12b to have the same acceleration and deceleration profiles when starting and stopping, respectively. For example, the acceleration and deceleration profiles can relate to how much torque or what target ramping speed the motors 36 should operate at when going from dead stops to steady state pumping or from steady state pumping to dead stops. The controller 28 can cause the motors 36 of pumps 12a, 12b to accelerate at the same rate such that both motors 36 reach a steady state pumping speed at the same time. The controller 28 can cause the motors 36 of pumps 12a, 12b to decelerate at the same rate, such that both motors 36 decelerate to a stop at the same time. Controlling the motors 36 for the same acceleration and/or deceleration profiles provides on-ratio mixing as the pumps 12a, 12b reach the steady state and stopped conditions at the same time, providing consistent flow during both acceleration and deceleration.

In some examples, the controller 28 can control the respective motors 36 of the pumps 12a, 12b to have synchronous changeovers between the fluid displacers 40 of the respective pumps 12a, 12b. In this way, the fluid displacer 40 of pump 12a changes over in synchrony with the fluid displacer 40 of pump 12b. In some cases, if a sensor indicates a mismatch in synchrony (e.g., determined based on position of the rotor or fluid displacer 40 sensed by pump sensor 44; based on changes in current draw; based on sensed pressure fluctuations from pump sensor 44, sensor package 26a, and/or sensor package 26b; etc.), then the controller 28 can cause one of the pumps 12a, 12b to speed up and/or the other pump 12a, 12b to slow down until synchrony is reached for simultaneous changeover. In some examples, if the sensor indicates a mismatch in synchrony, then the controller 28 can cause one of pumps 12a, 12b to pause until the other one of pumps 12a, 12b catches up and the paused one of pumps 12a, 12b can be restarted following the pause, timed to be in sync with the cycle of the other one of pumps 12a, 12b.

In some examples, controller 28 can control the respective motors 36 of pumps 12a, 12b to have synchronous changeover even if a fluid displacer 40 is not at the end of a pump stroke. The controller 28 can determine that the fluid displacer 40 of one of pumps 12a, 12b is moving through changeover and can command the other pump 12a, 12b to changeover stroke direction of its fluid displacer 40. For example, the motors 36 can be configured such that the rotor can rotate in either of two rotational directions relative to the stator. The controller 28 can command a motor 36 to reverse direction to cause changeover at any point in a pump stroke. The controller 28 can cause the other pump 12a, 12b to changeover stroke direction even if the fluid displacer 40 of that other pump 12a, 12b is at a location between the ends of its full stroke length.

In some examples, the controller 28 can control pumps 12a, 12b for synchronous speed based on changeover. For example, the controller 28 can cause pumps 12a to pause when the fluid displacer 40 of pump 12b moves through changeover. The fluid displacer 40 pauses, at least briefly, when it moves through changeover between stroke directions. Pausing displacement of the fluid displacer 40 of pump 12a while the fluid displacer 40 of pump 12b moves through changeover maintains on-ratio mixing by having both pumps 12a, 12b outputting simultaneously and being paused simultaneously. In some examples, the changeover can be determined based on the determined positions of the fluid displacers 40 of the pumps 12a, 12b based on the pump parameter information from pump sensors 44 of pumps 12a, 12b. For example, changeover can be determined based on the rotational position of the rotor, the linear position of the fluid displacer 40, current draw, etc. In some examples, the changeover can be determined based on pressure fluctuations sensed by sensors of the sensor packages 26a, 26b. On changeover, the pressure output from a pump 12a, 12b drops, on which the controller 28 can cause the other pump 12a, 12b that is not going through changeover to stop. A subsequent increase in pressure indicates that the fluid displacer 40 has completed changeover and is again moving through a stroke, on which the controller 28 can cause the other pump 12a, 12b to resume pumping.

In some examples, the controller 28 can cause the fluid displacer 40 of a first one of pump 12a, 12b to go through changeover based on changeover of the fluid displacer 40 of a second one of pumps 12a, 12b when the fluid displacer 40 of the first one of pumps 12a, 12b is within a threshold distance of the end of its stroke. For example, the controller 28 can cause the fluid displacer 40 of the first one of pumps 12a, 12b to move through changeover if that fluid displacer 40 is within 3%, 5%, 10%, 15%, etc. of the stroke length from the end of the pump stroke. The controller 28 can cause the fluid displacer 40 of the first one of pumps 12a, 12b to continue through the same pump stroke and not changeover when the fluid displacer 40 is outside of the threshold distance such that the fluid displacer 40 is further away from the end of the pump stroke than the threshold distance. Causing the fluid displacer 40 of the first one of pumps 12a, 12b to move through changeover when within the threshold distance prevents short strokes before changeover, such as in examples when the first one of pumps 12a, 12b pauses based on the fluid displacer 40 of the second one of pumps 12a, 12b moving through a changeover and then resumes pumping. Such a configuration provides for efficient pumping with fewer pauses in pumping, providing for more consistent delivery of the constituent materials.

In some examples, if the pumps 12a, 12b are not supplying a 1:1 ratio, then only some of the changeovers can be synced. For example, a first one of pumps 12a, 12b can operate faster than a second one of pumps 12a, 12b, such as by having a different (e.g., higher or lower) motor speed in examples in which the pumps 12a, 12b are sized for 1:1 output ratio. For example, pump 12a can be configured to pump a first constituent material that mixes at a 2:1 ratio with a second constituent material pumped by pump 12b. The controller 28 can cause the first pump 12a to move at twice the speed of the second pump 12b. In such an example, the slower pump 12b will changeover less frequently than the first pump 12a if the full stroke lengths are utilized. The controller 28 can control pumps 12a, 12b such that changeovers are synched when both pumps 12a, 12b are changing over, such as for every other stroke of the first pump 12a and on each stroke of the second pump 12b in the 2:1 ratio example.

In such examples, the controller 28 can assign either the first pump 12a, 12b, pumping at a higher rate, or the second pump 12a, 12b, pumping at a lower rate, as the lead pump and the other pump 12a, 12b as the follower pump such that the speed of the follower pump is based on the speed of the lead pump. The controller 28 can assign the lead pump based on the resistances encountered by the pumps 12a, 12b during pumping, as discussed above. As such, either of the faster pump 12a, 12b or the slower pump 12a, 12b can be designated as the lead pump and the other pump 12a, 12b is designated as the follower pump.

In some examples, changeovers can be synced by not using the entire stroke length for one or both of the pumps 12a, 12b. For example, when the first pump 12aI moving at a first speed must changeover due to end of its stroke length, the second pump 12b moving at a second speed different from the first speed can changeover in synchrony even if the second pump 12b is not at the end of its stroke length. For example, when pumping at a 2:1 ratio the faster one of pumps 12a, 12b can utilize a full stroke length and the slower one of pumps 12a, 12b can utilize half of the available stroke length. In such an example, controller 28 can control pumps 12a, 12b such that each changeover is synched.

In various examples, the sensor package 26c monitors one or more parameters of the compressed gas and communicates parameter data indicative of the one or more parameters to the controller 28. The controller 28 can then control one or more other components of the system 10 in response to the parameter information from the sensor package 26c indicative of a parameter of the compressed gas. For example, if the rate of flow or pressure of compressed gas falls below a threshold (or is zero), then the controller 28 can decrease the output from (or stop) the pumps 12a, 12b.

In some examples, an output from a pump sensor 44 of either pump 12, the first sensor package 26a, and/or the second sensor package 26b can cause the controller 28 to modulate the supply of compressed gas, such as by increasing or decreasing the pressure and/or flow of the compressed gas supplied to the applicator 18. For example, if increased pressure and/or flow of the first and/or second constituent materials is sensed, then the controller 28 can also increase the supply of pressurized gas to the applicator 18. If no flow of the first and/or second constituent materials is sensed by the pump sensor 44 of either pump 12a, 12b, by the first sensor package 26a, and/or by the second sensor package 26b, then the supply of compressed gas can be reduced or stopped, such as by the closure of the valve of sensor package 26c or gas supply 20 or stopping a compressor forming gas supply 20.

An output setting input can be received from user interface 34 and communicated to the controller 28. The user can provide the output setting input to user interface 34, such as to set the target output parameter from pumps 12a, 12b (e.g., to set the desired pressure, flow rate, etc.). The output setting input can indicate a desire to output a higher volume of plural component material or a lower volume of plural component material. The output setting input can indicate a desire to output at a higher pressure or lower pressure. The controller 28 can then control each of the pumps 12a, 12b and the gas supply 20 to change volume and/or pressure output based on the output setting input from the user. For example, if the user inputs a command for a higher pressure and/or higher volume of plural component material output, then the controller 28 can instruct the motors 36 of the pumps 12a, 12b to speed up to increase the volume and/or pressure output. The controller 28 can also control the gas supply 20 to increase the flow rate and/or pressure of the gas supplied to the applicator 18, such as by a solenoid actuated regulator or by increasing the speed of a compressor of the gas supply 20, amongst other options. For example, if the user inputs a command for a lower pressure and/or lower volume of plural component material output, then the controller 28 can instruct the motors 36 of the pumps 12a, 12b to decrease speed to decrease the volume and/or pressure output. The controller 28 can also control the gas supply 20 to decrease the flow rate and/or pressure of the gas supplied to the applicator 18, such as by a solenoid actuated regulator or by decreasing the speed of a compressor of the gas supply 20, amongst other options.

As shown, there is only one pump 12a between the first fluid reservoir 14a and the applicator 18 for the supplying the first constituent material. Likewise, there is only one pump 12b between the second fluid reservoir 14b and the applicator 18 for supplying the second constituent material. As such, the pump 12a, 12b that is partially immersed provides all of the airless fluid pressure feeding the applicator 18 for that constituent material provided by that pump 12a, 12b. There are no intermediary pumps along the fluid paths. System 10 does not include a pump downstream of pump 12a for pumping the first constituent material to the applicator 18. System 10 does not include a pump downstream of pump 12b for pumping the second constituent material to the applicator 18. System 10 does not include a pump upstream of pump 12a for pumping the first constituent material to pump 12a. System 10 does not include a pump upstream of pump 12b for pumping the second constituent material to pump 12b. System 10 does not include mechanically linked pumps. The pump 12a, 12b are individually operable and individually controllable. The fluid displacers 40 of the pumps 12a, 12b are not mechanically linked for simultaneous displacement. System 10 does not include a proportioner that includes mechanically linked pumps to provide the constituent materials on-ratio. Instead, controller 28 actively controls operation of pumps 12a, 12b such that pumps 12a, 12b provide the constituent materials to applicator 18 on-ratio.

In some examples, the controller 28 controls operation of system 10 based on the pump parameter information generated by pump sensors 44. In such an example, the controller 28 does not require and may not utilize material parameter information from sensor packages 26a, 26b to control operation of the pumps 12a, 12b. In some such examples, system 10 does not include sensor packages 26a, 26b and does not include sensors that directly sense parameters of the constituent materials downstream of pumps 12a, 12b. In some such examples, the controller 28 may receive material parameter information from a sensor package 26a, 26b but the controller 28 does not rely on the material parameter information to control operation of pumps 12a, 12b.

Pump sensor 44 can generate pump parameter information regarding the displacement of the fluid displacer 40, such as by directly sensing a linear position and/or displacement speed of the fluid displacer 40 or by sensing a rotational position and/or rotational speed of the rotor of the motor 36 from which a position of the fluid displacer 40 can be determined. In some examples, the output flow rate from the pump 12a, 12b can be determined based on the displacement of the fluid displacer 40, such as based on the rate of displacement of either the fluid displacer 40 or the rotor of the motor 36. The current level provided to motor 36 is known during operation and can vary based on the resistance encountered by the pump 12a, 12b during pumping. For example, a relatively greater current level will be required to pump more viscous material at a target pressure and a relatively lesser current level will be required to pump less viscous material at the target pressure. In some examples, the output pressure of the pump 12a, 12b can be determined based on the current draw of the motor 36 of the pump 12a, 12b.

The controller 28 can be configured to control operation of pumps 12a, 12b based solely on pump parameter data, such as current draw and/or displacement of the fluid displacer 40. The controller 28 can regulate power to the motors 36 of the pumps 12a, 12b to control operation of each pump 12a, 12b.

The controller 28 can cause pumps 12a, 12b to increase or decrease flow output based on the current draw of one or the other of pumps 12a, 12b. A decrease in current draw can indicate a corresponding drop in pressure, such that the controller 28 can cause an increase in electric power to the pumps 12a, 12b to increase pressure. An increase in current draw can indicate a corresponding rise in pressure, such that controller 28 can cause a reduction in electric power to pumps 12a, 12b to decrease pressure. A change in current draw can indicate a corresponding change in flow rate, such that the controller 28 can cause an increase or decrease in electric power to the pumps 12a, 12b to decrease or increase flow rate.

The controller 28 can cause pumps 12a, 12b to increase or decrease flow output based on the sensed displacement of the fluid displacers 40 of the pumps 12a, 12b, which displacement can be directly sensed based on fluid displacer 40 or indirectly sensed based on the rotor of the motor 36. A decrease in speed can indicate a corresponding drop in flow rate, such that the controller 28 can cause an increase in electric power to the pumps 12a, 12b to increase flow rate. An increase in speed can indicate a corresponding rise in flow rate, such that controller 28 can cause a reduction in electric power to pumps 12a, 12b to decrease flow rate. A change in displacement speed can indicate a corresponding change in pressure, such that the controller 28 can cause an increase or decrease in electric power to the pumps 12a, 12b to decrease or increase pressure.

In some examples, the controller 28 can assign lead pump status to one of pumps 12a, 12b and can assign follower pump status to the other one of pumps 12a, 12b based solely on the pump parameter information. For example, the controller 28 can determine which of pumps 12a, 12b is the lead pump based on current draw of the motors 36 of the pumps 12a, 12b. In some examples, the controller 28 can determine the output pressure of the first constituent material based on the current draw of the electric motor 36 of pump 12a. In some examples, the controller 28 can determine the pressure output of the second constituent material based on the current draw of the electric motor 36 of pump 12b. The controller 28 can assign the pump 12a, 12b having the greater current draw as the lead pump and control operation of the other pump 12a, 12b based on operation of the lead pump. For example, pump 12a may have a greater current draw to achieve the target output parameter, controller 28 will then assign pump 12a lead pump status and pump 12b follower pump status. The controller 28 then controls operation of the follower pump 12b based on operation of the lead pump 12a, such as by causing pump 12b to displace its fluid displacer 40 at a speed based on the speed of displacement of the fluid displacer 40 of pump 12a.

As discussed above, the controller 28 can control operation of the pumps 12a, 12b based on a target output parameter that is input at the user interface 34. The target output parameter can be a target pressure, a target flow rate, etc.

In examples in which the target output parameter is a target pressure, the controller 28 can control operation of the pumps 12a, 12b based on the current draw of the electric motors 36 of the pumps 12a, 12b. The current draw is indicative of the actual pressure at which the pumps 12a, 12b are pumping. For example, the pressure output by pump 12a can be determined based on a current draw of the electric motor 36 of pump 12a. For example, the pressure output by pump 12b can be determined based on a current draw of the electric motor 36 of pump 12b. Controller 28 can control operation of pumps 12a, 12b to achieve the target pressure without receiving pressure information for the first constituent material from a pressure sensor and without receiving pressure information for the second constituent material from a pressure sensor.

In examples in which the target output parameter is a target flow rate, the controller 28 can control operation of pumps 12a, 12b based on positional information of the pumps 12a, 12b. For example, the flow rate output by pump 12a can be determined based on a rate of displacement of the fluid displacer 40 of pump 12a, which rate of displacement can be determined based on directly sensing displacement of the fluid displacer 40 of pump 12a or based on directly sensing the rotational displacement of the rotor of the electric motor 36 of pump 12a. For example, the flow rate output by pump 12b can be determined based on a rate of displacement of the fluid displacer 40 of pump 12b, which rate of displacement can be determined based on directly sensing displacement of the fluid displacer 40 of pump 12b or based on directly sensing the rotational displacement of the rotor of the electric motor 36 of pump 12b. Controller 28 can control operation of pumps 12a, 12b to achieve the target flow rate without receiving flow rate information for the first constituent material from a flow sensor and without receiving flow rate information for the second constituent material from a flow sensor.

Controller 28 controlling operation of system 10 based on pump parameter information provides significant advantages. Controller 28 can receive information regarding pumps 12a, 12b and controls operation of pumps 12a, 12b based on that pump parameter information. The controller 28 does not require parameter information sensed from the flows output from pumps 12a, 12b. Instead, the controller 28 controls operation of pumps 12a, 12b based on the parameter information from the pumps 12a, 12b themselves. Such a configuration eliminates the need for pressure and/or flow sensors, providing a less costly and easier to operate system 10. Controlling operation of the pumps 12a, 12b based on the pump parameter information also provides for a more responsive system that directly controls the pumps 12a, 12b based on parameter data from the pumps 12a, 12b, rather than based on material parameter data of the first and second constituent materials generated at a location downstream of the pumps 12a, 12b.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A plural component system comprising:
a first pump for pumping a first constituent material, the first pump having a first electric motor;
a second pump for pumping a second constituent material, the second pump having a second electric motor;
an applicator configured to receive the first constituent material and the second constituent material and emit a plural component material formed by mixing of the first constituent material and the second constituent material; and
a controller operatively connected to the first electric motor to control pumping by the first pump and to the second electric motor to control pumping by the second pump, the controller configured to:
receive first parameter information regarding a first output of the first pump and second parameter information regarding a second output of the second pump;
designate a pump status to the first pump and the second pump based on the first parameter information and the second parameter information, wherein the controller designates one of the first pump and the second pump as a lead pump and designates an other one of the first pump and the second pump as a follower pump; and
control operation of the follower pump such that a displacement speed of a fluid displacer of the follower pump is based on a displacement speed of a fluid displacer of the lead pump.

2. The plural component system of claim 1, wherein the displacement speed of the fluid displacer of the follower pump is maintained at a 1:1 ratio with the displacement speed of the fluid displacer of the lead pump.

3. The plural component system of claim 1, wherein the first parameter information regarding the first output is generated by a pump sensor of the first pump.

4. The plural component system of claim 3, wherein the pump sensor is a motor sensor configured to generate information regarding at least one of a rotational position of a first rotor of the first electric motor and a rotational speed of the first rotor of the first electric motor.

5. (canceled)

6. (canceled)

7. The plural component system of claim 1, further comprising:
a first sensor package comprising one or more sensors for sensing one or more parameters of the first constituent material and generating the first parameter information;
a second sensor package comprising one or more sensors for sensing one or more parameters of the second constituent material and generating the second parameter information.

8. The plural component system of claim 7, wherein;
the first sensor package includes at least one of a first pressure sensor configured to generate first pressure data regarding a first pressure of the first constituent material and a first flow sensor configured to generate first flow data regarding a flow rate of the first constituent material; and
the second sensor package includes at least one of a second pressure sensor configured to generate second pressure data regarding a second pressure of the second constituent material and a second flow sensor configured to generate second flow data regarding a flow rate of the second constituent material.

9-11. (canceled)

12. The plural component system of claim 1, further comprising:
a user interface configured to receive an output setting from a user, the output setting providing a target output parameter for pumping;
wherein the controller is configured to designate the pump status based on the output setting.

13. The plural component system of claim 12, wherein the target output parameter is one of a target pressure level and a target flow rate.

14. (canceled)

15. The plural component system of claim 12, wherein the controller is configured to designate the one of the first pump and the second pump as the lead pump based on whichever of the first output and the second output is first to satisfy a designation threshold, the designation threshold based on the target output parameter.

16. (canceled)

17. The plural component system of claim 12, wherein the controller is configured to designate the one of the first pump and the second pump as the lead pump based on an average parameter value between the first output and the second output satisfying a designation threshold, the designation threshold based on the target output parameter.

18. (canceled)

19. (canceled)

20. The plural component system of claim 1, wherein the fluid displacer of the lead pump and the fluid displacer of the follower pump are not mechanically linked for pumping.

21. The plural component system of claim 1, wherein no pump is disposed downstream of the first pump to pump the first constituent material to the applicator.

22. (canceled)

23. The plural component system of claim 1, further comprising:
a first heater disposed between the first pump and the applicator to heat the first constituent material; and
a second heater disposed between the second pump and the applicator to heat the second constituent material;
wherein the controller is configured to control a thermal output of at least one of the first heater and the second heater based on at least one of the first parameter information and the second parameter information.

24. (canceled)

25. The plural component system of claim 1, further comprising:
a gas supply fluidly connected to the applicator to provide compressed gas to the applicator; and
wherein the controller is configured to control a compressed gas output from the gas supply based on at least one of the first parameter information and the second parameter information.

26. (canceled)

27. (canceled)

28. The plural component system of claim 1, wherein the controller is configured to dynamically designate the pump status.

29. The plural component system of claim 28, wherein the controller is configured to reassign pump statuses between the first pump and the second pump based on the first parameter information and the second parameter information indicating that an output parameter of the other one of the first pump and the second pump has overtaken an output parameter of the one of the first pump and the second pump.

30. The plural component system of claim 28, wherein the controller is configured to reassign pump statuses between the first pump and the second pump based on the first parameter information and the second parameter information indicating that an output parameter of the follower pump meets a status threshold.

31. (canceled)

32. The plural component system of claim 30, wherein controller determines whether the output parameter of the follower pump meets the status threshold based on at least one of a comparison of current draw of the first electric motor and current draw of the second electric motor, and a comparison of a pressure of the first constituent material and a pressure of the second constituent material.

33-36. (canceled)

37. A plural component system comprising:
a first pump for pumping a first constituent material, the first pump having a first electric motor;
a second pump for pumping a second constituent material, the second pump having a second electric motor;
an applicator configured to receive the first constituent material and the second constituent material and emit a plural component material formed by mixing of the first constituent material and the second constituent material; and
a controller operatively connected to the first electric motor to control pumping by the first pump and to the second electric motor to control pumping by the second pump, the controller configured to:
receive first parameter information regarding a first output of the first pump and second parameter information regarding a second output of the second pump;
designate a pump status to the first pump and the second pump based on the first parameter information and the second parameter information, wherein the controller designates one of the first pump and the second pump as a lead pump and designates an other one of the first pump and the second pump as a follower pump;
control operation of the follower pump such that a displacement speed of a fluid displacer of the follower pump is based on a displacement speed of a fluid displacer of the lead pump; and
redesignate the other one of the first pump and the second pump as the lead pump and the one of the first pump and the second pump as the follower pump based on the first parameter information and the second parameter information indicating that an output parameter of the other one of the first pump and the second pump has overtaken an output parameter of the one of the first pump and the second pump.

38-44. (canceled)

45. A plural component system comprising:
a first pump for pumping a first constituent material, the first pump having a first electric motor;
a second pump for pumping a second constituent material, the second pump having a second electric motor;
an applicator configured to receive the first constituent material and the second constituent material and emit a plural component material formed by mixing of the first constituent material and the second constituent material;
a user interface configured to receive an output setting from a user, the output setting providing a target output parameter for the plural component material; and
a controller operatively connected to the first electric motor to control pumping by the first pump and to the second electric motor to control pumping by the second pump, the controller configured to:
receive first pump parameter information regarding the first pump;
receive second pump parameter information regarding the second pump; and
control operation of the first pump and the second pump based on the output setting, the first pump parameter information, and the second pump parameter information such that the first pump and the second pump output the first constituent material and the second constituent material at a desired ratio.

46-76. (canceled)
